(19) United States
(12) Patent Application Publication
(10) Pub. No.: US 2026/0027785 A1
(43) Pub. Date: Jan. 29, 2026

(54) Wrap Film Joint Structure and Crop Wrap Film

(71) Applicants: Qianghua SHEN, Shaoxing (CN); Shenfei Packaging Novel Material (Shaoxing) Co., Ltd, Shaoxing (CN)

(72) Inventor: Qianghua SHEN, Shaoxing (CN)

(73) Assignees: Qianghua SHEN, Shaoxing (CN); Shenfei Packaging Novel Material (Shaoxing) Co., Ltd, Shaoxing (CN)

(21) Appl. No.: 18/944,018

(22) Filed: Nov. 12, 2024

(30) Foreign Application Priority Data
Jul. 23, 2024 (CN) 202421749864.9

(51) Int. Cl. B29C 65/00; A01F 15/07; B29C 65/48

(52) U.S. Cl. CPC B29C 66/43; B29C 65/48; B29C 66/12221; A01F 2015/0745

(57) ABSTRACT

A wrap film joint structure and a crop wrap film are provided. The wrap film joint structure includes: tear lines provided on a wrap film, and allowing the wrap film to break at the tear lines, where the wrap film breaking at each of the tear lines includes a previous section of the wrap film and a subsequent section of the wrap film; and a connecting layer including a first connecting layer and a second connecting layer; where the first connecting layer is partially connected to the second connecting layer, partially connected to the subsequent section of the wrap film, and partially connected to the previous section of the wrap film; and the second connecting layer is connected to the previous section of the wrap film through a first adhesive layer.

### CROSS REFERENCE TO THE RELATED APPLICATIONS

This application is based upon and claims priority to Chinese Patent Application No. 202421749864.9, filed on Jul. 23, 2024, the entire contents of which are incorporated herein by reference.

### TECHNICAL FIELD

The present disclosure relates to the technical field of wrap materials, and in particular to a wrap film joint structure and a crop wrap film.

### BACKGROUND

Cotton picking and wrapping integrated machines can achieve mechanization throughout cotton picking and wrapping. They effectively avoid a problem of traditional cotton picking machines being contaminated by impurities such as hair during cotton transportation, greatly improving cotton quality, and solve a series of problems from cotton picking and transportation to stacking and storage in cotton ginning mills.

Cotton wrap film is a material used for wrapping cotton bales, with one section of the cotton wrap film corresponding to wrapping of a cotton bale. In order to facilitate storage and automate wrapping of cotton, during the production process, multiple independent sections of the cotton wrap film are usually connected end-to-end through a joint structure to form a rolled structure.

In China, the existing cotton wrap film joint solution adopts the product structure of importers, namely the “Z-lock” two-section film splicing form. For example, patent document CN200580020614.5 discloses a wrap material using a Z-lock system and manufacturing and usage methods thereof (the corresponding US patent application is U.S. Pat. No. 88,496,604A). In the disclosure, the cotton wrap films are connected through a Z-lock structure, but this structure has the following drawbacks in practical use.

As shown in FIG. 1, the previous and subsequent sections of the wrap film are subjected to complex processing such as splicing and folding, resulting in low production efficiency and low product yield. During the unrolling process of the wrap film roll 1 by a device, the connection portion is prone to premature disconnection due to the shear force at the conveyor roller. As a result, the subsequent section of the wrap film cannot be picked up by the conveyor roller 2 or conveyor roller 3 and transported to the wrapping station of the target object 4.

Patent document CN220200104U discloses a wrap film joint structure and a crop wrap film, solving the problem of complex processing such as splicing and folding of the previous and subsequent sections of the wrap film. However, during the unrolling process, under the action of tension, due to the low bonding force of the release film, the connection position between the release film and the previous section of the wrap film is prone to break before the tear line. Therefore, it is still likely that the subsequent section of the wrap film may not be picked up by the conveyor roller 2 or conveyor roller 3 and transported to the wrapping station of the target object 4.

### SUMMARY

In view of the defects in the prior art, an objective of the present disclosure is to provide a wrap film joint structure and a crop wrap film.

The present disclosure provides a wrap film joint structure, including:
tear lines 6, provided on a wrap film 5, and allowing the wrap film 5 to break at the tear lines 6, where the wrap film 5 breaking at each of the tear lines 6 includes a previous section 501 of the wrap film and a subsequent section 502 of the wrap film; and
a connecting layer, including a first connecting layer 9 and a second connecting layer 10; and
where, the first connecting layer 9 is partially connected to the second connecting layer 10, partially connected to the subsequent section 502 of the wrap film, and partially connected to the previous section 501 of the wrap film; and the second connecting layer 10 is connected to the previous section 501 of the wrap film through a first adhesive layer 7.

Further, a length of the connecting layer is greater than a length of the wrap film 5 between the first adhesive layer 7 and a connection position of the connecting layer in the subsequent section 502 of the wrap film.

Further, a bonding force between the first connecting layer 9 and the previous section 501 of the wrap film is greater than a bonding force between the previous section 501 of the wrap film and the subsequent section 502 of the wrap film;
the bonding force between the first connecting layer 9 and the previous section 501 of the wrap film is smaller than a bonding force between the first connecting layer 9 and the subsequent section 502 of the wrap film; and
a bonding force between the second connecting layer 10 and the first connecting layer 9 is greater than a bonding force between the second connecting layer 10 and the first adhesive layer 7, and a bonding force between the first adhesive layer 7 and the previous section 501 of the wrap film is greater than the bonding force between the second connecting layer 10 and the first adhesive layer 7.

Further, the first connecting layer 9 includes a first end portion and a second end portion; the first end portion is bonded to the subsequent section 502 of the wrap film through a second adhesive layer 8; and alternatively, the first end portion is fixedly connected to the subsequent section 502 of the wrap film; and the second end portion is connected to the second connecting layer 10.

Further, the second connecting layer 10 is in a flat state between the second end portion and the first adhesive layer 7; alternatively, the second connecting layer 10 is in a folded state between the second end portion and the first adhesive layer 7; the second end portion and the first adhesive layer 7 are bonded to a same side of the second connecting layer 10; a connection area between the second connecting layer 10 and the second end portion is greater than a connection area between the second connecting layer 10 and the first adhesive layer 7; and alternatively, the second connecting layer 10 is fixedly connected to the second end portion.

Further, the second connecting layer 10 includes a release layer; a release surface of the release layer is bonded to the first adhesive layer 7; and a non-release surface of the second connecting layer 10 is connected to the second end portion.

Further, the first connecting layer 9 is in a folded state, with a bending position bonded to the previous section 501 of the wrap film.

Further, the first connecting layer 9 and the wrap film 5 are made of a same material.

The present disclosure provides a crop wrap film, including a wrap film 5 and the above wrap film joint structure, where the wrap film joint structure is located on the wrap film 5.

Further, the crop wrap film includes a cotton wrap film.

Compared with the prior art, the present disclosure has the following beneficial effects:

The wrap film joint structure of the present disclosure can be prepared in advance and connected to the wrap film through a simple bonding process. The connecting layer includes a first connecting layer and a second connecting layer. The first connecting layer is bonded to the previous section of the wrap film to avoid the wrap film joint structure breaking before the tear line and ensure that the wrap film joint structure is fully stretched after the tear line breaks. Through the second connecting layer, the wrap film joint structure is easy to separate from the previous section of the wrap film. In this way, the first connecting layer stretched by the previous section of the wrap film can be smoothly separated before the previous section of the wrap film, and the first connecting layer remains on the subsequent section of the wrap film as a leader to be picked up by the wrapping device.

### BRIEF DESCRIPTION OF THE DRAWINGS

Other features, objectives, and advantages of the present disclosure will become more apparent by reading the detailed description of non-limiting embodiments with reference to the following drawings.

FIG. 1 is a schematic diagram of a traditional wrap film during unrolling and wrapping;

FIG. 2 is a lateral view of a first wrap film joint structure according to the present disclosure;

FIG. 3 is a schematic diagram of the first wrap film joint structure during wrapping according to the present disclosure;

FIG. 4 is a lateral view of a second wrap film joint structure according to the present disclosure; and

FIG. 5 is a schematic diagram of the second wrap film joint structure during wrapping according to the present disclosure.

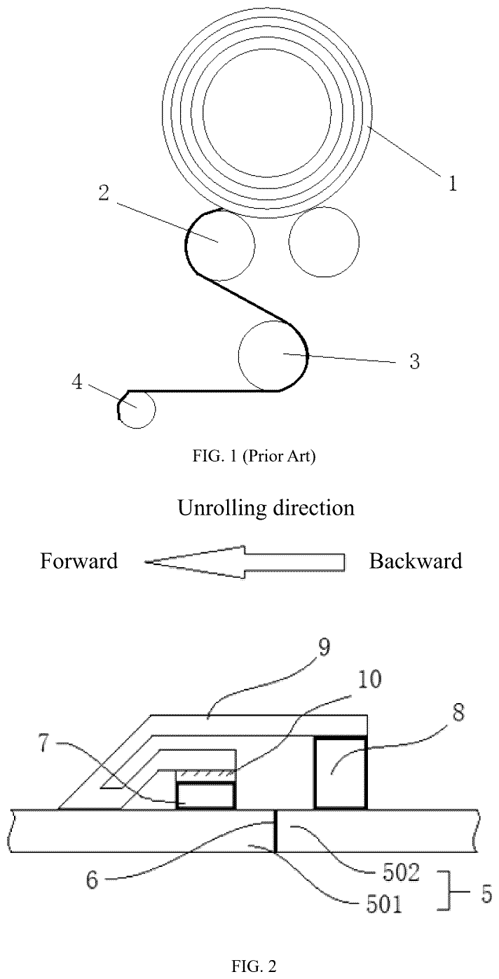

### DETAILED DESCRIPTION OF THE EMBODIMENTS

The following describes the present disclosure in detail in conjunction with specific embodiments. The following embodiments will be conducive to further understanding of the present disclosure by a person of ordinary skill in the art, but does not limit the present disclosure in any form. It should be noted that several variations and improvements can also be made by a person of ordinary skill in the art without departing from the conception of the present disclosure. These variations and improvements shall fall within the protection scope of the present disclosure.

### Embodiment 1

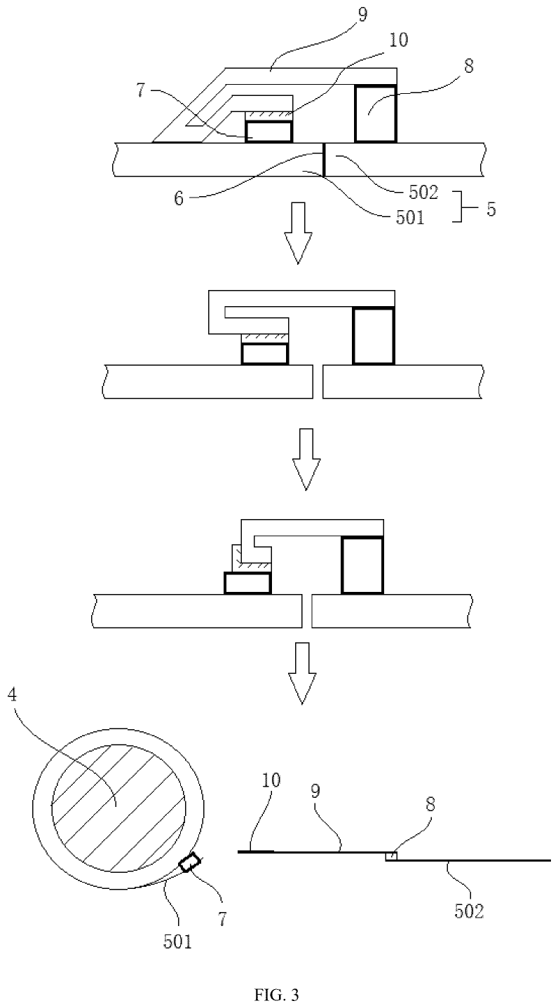

The present disclosure provides a wrap film joint structure. As shown in FIGS. 2 and 3, wrap film 5 is provided with tear lines 6. The tear line 6 can be a dashed cutting line prepared by punching holes, or a straight line segment prepared by cutting. The wrap film is easy to break at the tear line, forming a section of wrap film with a required length for wrapping a target object. The wrap film 5 breaking at each of the tear lines 6 includes previous section 501 of the wrap film and subsequent section 502 of the wrap film. There is no limit to the number of the tear lines 6, which can be set according to actual needs. The direction of the tear line 6 is usually set to a width direction of the wrap film 5, which is not limited herein.

The wrap film joint structure further includes a connecting layer. The connecting layer includes first connecting layer 9 and second connecting layer 10. The first connecting layer 9 is partially connected to the second connecting layer 10, partially connected to the subsequent section 502 of the wrap film, and partially connected to the previous section 501 of the wrap film. The second connecting layer 10 is connected to the previous section 501 of the wrap film through first adhesive layer 7. A length of the connecting layer is greater than a length of the wrap film 5 between the first adhesive layer 7 and a connection position of the connecting layer in the subsequent section 502 of the wrap film. The design can preliminarily avoid the connecting layer from disconnecting before the tear line 6 during the stretching process of the wrap film 5.

It should be noted that:

A bonding force between the first connecting layer 9 and the previous section 501 of the wrap film is greater than a bonding force between the previous section 501 of the wrap film and the subsequent section 502 of the wrap film. On the one hand, the design further avoids the connecting layer from disconnecting before the tear line 6 during the stretching process of the wrap film 5. On the other hand, the design can provide protection for the connection between the second connecting layer 10 and the first adhesive layer 7, avoiding their separation or displacement due to weak bonding force.

The bonding force between the first connecting layer 9 and the previous section 501 of the wrap film is smaller than a bonding force between the first connecting layer 9 and the subsequent section 502 of the wrap film. In this way, when the wrap film joint structure is stretched, it separates from the previous section 501 of the wrap film and remains on the subsequent section 502 of the wrap film as a leader.

A bonding force between the second connecting layer 10 and the first connecting layer 9 is greater than a bonding force between the second connecting layer 10 and the first adhesive layer 7, and a bonding force between the first adhesive layer 7 and the previous section 501 of the wrap film is greater than the bonding force between the second connecting layer 10 and the first adhesive layer 7. In this way, the second connecting layer 10 can be separated from the first adhesive layer 7, while the first adhesive layer 7 remains on the previous section 501 of the wrap film and can bond an end of the previous section 501 of the wrap film to a wrapped body after wrapping is completed.

In this embodiment, the first connecting layer 9 cannot be a release layer and can be made of the same material as the wrap film 5. The first connecting layer is partially bonded to the subsequent section 502 of the wrap film by means of direct fixation or second adhesive layer 8, partially directly bonded to the previous section 501 of the wrap film, and partially connected to the second connecting layer 10. The second connecting layer 10 is bonded to the previous section 501 of the wrap film through the first adhesive layer 7, and the second connecting layer 10 can be a release layer. Specifically, the first connecting layer 9 includes a first end portion and a second end portion. The first end portion is bonded to the subsequent section 502 of the wrap film through the second adhesive layer 8. Alternatively, the first end portion can be fixedly connected to the subsequent section 502 of the wrap film. The second end portion is connected to the second connecting layer 10.

The first connecting layer 9 has a large length. In view of this, in order to facilitate smooth rolling and storage, the first connecting layer 9 is in a folded state. The first connecting layer 9 includes a first end portion and a second end portion. Among the first end portion and the second end portion of the first connecting layer 9, the first end portion is bonded to the subsequent section 502 of the wrap film through the second adhesive layer 8. Alternatively, the first end portion can be fixedly connected to the subsequent section 502 of the wrap film. The second end portion is connected to the second connecting layer 10. The second connecting layer 10 is bonded to the previous section 501 of the wrap film through the first adhesive layer 7. A bending position of the first connecting layer 9 is located at the previous section of the wrap film 501, with an opening facing towards the subsequent section of the wrap film 502.

The longer first connecting layer 9 can form the leader of the subsequent section 502 of the wrap film, such that the subsequent section 502 of the wrap film can still be picked up and pulled by the device after the previous section 501 of the wrap film is separated from the subsequent section 502 of the wrap film. The second connecting layer 10 is in a flat state between the second end portion and the first adhesive layer 7. When the second connecting layer 10 is a release layer, a release surface of the second connecting layer 10 is bonded to the first adhesive layer 7, and a non-release surface is connected to the second end portion. In this way, the second connecting layer 10 can be separated from the first adhesive layer 7 and remain on the first connecting layer 9.

In this embodiment, there is a preset distance between a back side of the first adhesive layer 7 and the tear line 6. The preset distance is preferably greater than 0 and less than or equal to 50 mm. After rolling and wrapping a crop, the wrap film 5 within this distance extends beyond the wrapped crop roll. The purpose of the preset distance is to reduce the requirement for positioning accuracy when bonding the wrap film joint structure. If there is no preset distance (the preset distance equals 0), it is avoided that the unraveling of the secured and wrapped crop occurs due to the failure of bonding caused by that after rolling and wrapping, a portion of the wrap film 5 within the preset distance is subjected to a normal force under the squeezing and pulling of crop straw.

### Embodiment 2

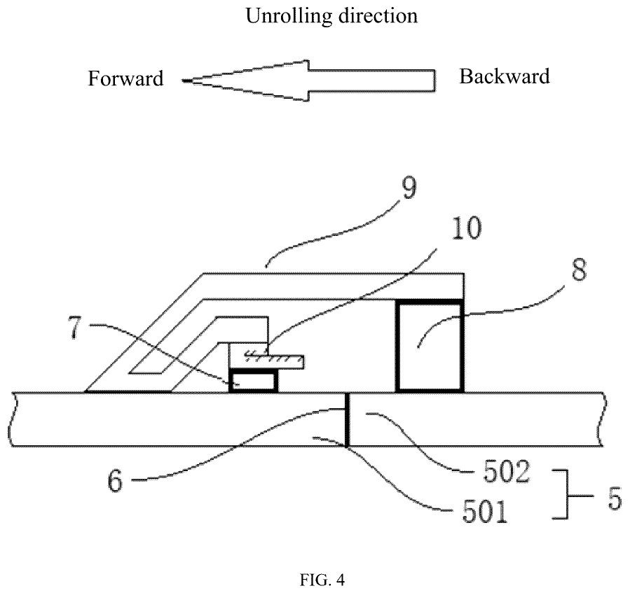

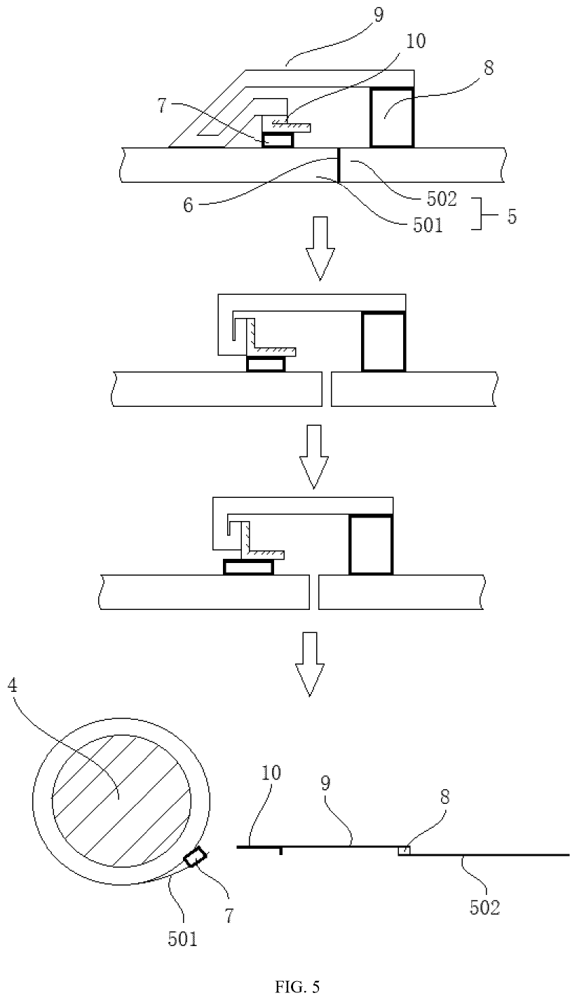

The present disclosure provides a wrap film joint structure. As shown in FIGS. 4 and 5, wrap film 5 is provided with tear lines 6. The tear line 6 can be a dashed cutting line prepared by punching holes, or a straight line segment prepared by cutting. The wrap film is easy to break at the tear line, forming a section of wrap film with a required length for wrapping a target object. There is no limit to the number of the tear lines 6, which can be set according to actual needs. The direction of the tear line 6 is usually set to a width direction of the wrap film 5 or a diagonal line inclined at a certain angle to the width direction, which is not limited herein.

The wrap film joint structure further includes a connecting layer. The connecting layer includes first connecting layer 9 and second connecting layer 10. The first connecting layer 9 is partially connected to the second connecting layer 10, partially connected to the subsequent section 502 of the wrap film, and partially connected to the previous section 501 of the wrap film. The second connecting layer 10 is connected to the previous section 501 of the wrap film through first adhesive layer 7. A length of the connecting layer is greater than a length of the wrap film 5 between the first adhesive layer 7 and a connection position of the connecting layer in the subsequent section 502 of the wrap film. The design can preliminarily avoid the connecting layer from disconnecting before the tear line 6 during the stretching process of the wrap film 5.

It should be noted that:

A bonding force between the first connecting layer 9 and the previous section 501 of the wrap film is greater than a bonding force between the previous section 501 of the wrap film and the subsequent section 502 of the wrap film. On the one hand, the design further avoids the connecting layer from disconnecting before the tear line 6 during the stretching process of the wrap film 5. On the other hand, the design can provide protection for the connection between the second connecting layer 10 and the first adhesive layer 7, avoiding their separation or displacement due to weak bonding force.

The bonding force between the first connecting layer 9 and the previous section 501 of the wrap film is smaller than a bonding force between the first connecting layer 9 and the subsequent section 502 of the wrap film. In this way, when the wrap film joint structure is stretched, it separates from the previous section 501 of the wrap film and remains on the subsequent section 502 of the wrap film as a leader.

A bonding force between the second connecting layer 10 and the first connecting layer 9 is greater than a bonding force between the second connecting layer 10 and the first adhesive layer 7, and a bonding force between the first adhesive layer 7 and the previous section 501 of the wrap film is greater than the bonding force between the second connecting layer 10 and the first adhesive layer 7. In this way, the second connecting layer 10 can be separated from the first adhesive layer 7, while the first adhesive layer 7 remains on the previous section 501 of the wrap film and can bond an end of the previous section 501 of the wrap film to a wrapped body after wrapping is completed.

In this embodiment, the first connecting layer 9 cannot be a release layer and can be made of the same material as the wrap film 5. The first connecting layer is partially bonded to the subsequent section 502 of the wrap film by means of direct fixation or second adhesive layer 8, partially directly bonded to the previous section 501 of the wrap film, and partially connected to the second connecting layer 10. The second connecting layer 10 is bonded to the previous section 501 of the wrap film through the first adhesive layer 7, and the second connecting layer 10 can be a release layer. Specifically, the first connecting layer 9 includes a first end portion and a second end portion. The first end portion is bonded to the subsequent section 502 of the wrap film through the second adhesive layer 8. Alternatively, the first end portion can be fixedly connected to the subsequent section 502 of the wrap film. The second end portion is connected to the second connecting layer 10.

The first connecting layer 9 has a large length. In view of this, in order to facilitate smooth rolling and storage, the first connecting layer 9 is in a folded state. The first connecting layer 9 includes a first end portion and a second end portion. Among the first end portion and the second end portion of the first connecting layer 9, the first end portion is bonded to the subsequent section 502 of the wrap film through the second adhesive layer 8. Alternatively, the first end portion can be fixedly connected to the subsequent section 502 of the wrap film. The second end portion is connected to the second connecting layer 10. The second connecting layer 10 is bonded to the previous section 501 of the wrap film through the first adhesive layer 7. A bending position of the first connecting layer 9 is located at the previous section of the wrap film 501, with an opening facing towards the subsequent section of the wrap film 502.

The longer first connecting layer 9 can form the leader of the subsequent section 502 of the wrap film, such that the subsequent section 502 of the wrap film can still be picked up and pulled by the device after the previous section 501 of the wrap film is separated from the subsequent section 502 of the wrap film. The second connecting layer 10 is in a folded state between the second end portion and the first adhesive layer 7. When the second connecting layer 10 is a release layer, the second end portion and the first adhesive layer 7 are bonded to the same side (release surface side) of the second connecting layer 10. A connection area between the second connecting layer 10 and the second end portion is greater than a connection area between the second connecting layer 10 and the first adhesive layer 7. Alternatively, the second connecting layer 10 is fixedly connected to the second end portion.

The release surface of the second connecting layer 10 is bonded to the first adhesive layer 7, and a non-release surface is connected to the second end portion. In this way, the second connecting layer 10 can be separated from the first adhesive layer 7 and remain on the first connecting layer 9.

In this embodiment, there is a preset distance between a back side of the first adhesive layer 7 and the tear line 6. The preset distance is preferably greater than 0 and less than or equal to 50 mm. After rolling and wrapping a crop, the wrap film 5 within this distance extends beyond the wrapped crop roll. The purpose of the preset distance is to reduce the requirement for positioning accuracy when bonding the wrap film joint structure. If there is no preset distance (the preset distance equals 0), it is avoided that the unraveling of the secured and wrapped crop occurs due to the failure of bonding caused by that after rolling and wrapping, a portion of the wrap film 5 within the preset distance is subjected to a normal force under the squeezing and pulling of crop straw.

### Embodiment 3

A crop wrap film includes a wrap film and the wrap film joint structure described in Embodiments 1 and 2 and located on the wrap film. The wrap film can be used for the rolling and wrapping of a crop, especially cotton.

### Embodiment 4

This embodiment provides a method for preparing a wrap film joint structure, including the following steps.

In a wrap film processing step, tear lines 6 are prepared on wrap film 5. The tear line 6 can be a dashed cutting line prepared by punching holes, or a straight line segment prepared by cutting. The wrap film is easy to break at the tear line, forming a section of wrap film with a required length for wrapping a target object.

In a preformed part preparation step, second connecting layer 10 is connected to a second end portion of first connecting layer 9, and the first connecting layer 9 is connected to first adhesive layer 7, or at the same time, a first end portion of the first connecting layer 9 is connected to second adhesive layer 8. This part of structure can be prepared in advance.

In a joint bonding step, the structure prepared by the preformed part preparation step is connected to the wrap film 5. Specifically, the first adhesive layer 7 is connected to previous section 501 of the wrap film, and the first end portion is fixedly connected or connected to subsequent section 502 of the wrap film through the second adhesive layer 8. The first connecting layer 9 is folded and bonded to the previous section 501 of the wrap film. The fixed connection may be achieved by means of ultrasonic welding, which is not limited herein.

In the description of the present disclosure, it needs to be understood the orientation or positional relationships indicated by terms, such as “up”, “down”, “front”, “rear”, “left”, “right”, “vertical”, “horizontal”, “top”, “bottom”, “inside”, and “outside”, are based on the orientation or positional relationship shown in the drawings, are merely for facilitating the description of the present disclosure and simplifying the description, rather than indicating or implying that an apparatus or element referred to must have a particular orientation or be constructed and operated in a particular orientation, and therefore shall not be interpreted as limiting the present disclosure.

The specific embodiments of the present disclosure are described as above. It should be understood that the present disclosure is not limited to the above specific embodiments. Those skilled in the art can make various changes or modifications within the scope of the claims, which does not affect the essence of the present disclosure. The embodiments of the present disclosure and features in the embodiments may be arbitrarily combined with each other in a non-conflicting situation.

What is claimed is:

1. A wrap film joint structure, comprising:
tear lines, provided on a wrap film, allowing the wrap film to break at the tear lines, wherein the wrap film breaking at each of the tear lines comprises a previous section of the wrap film and a subsequent section of the wrap film;
a connecting layer, comprising a first connecting layer and a second connecting layer;
wherein, the first connecting layer is partially connected to the second connecting layer, partially connected to the subsequent section of the wrap film, and partially connected to the previous section of the wrap film; and the second connecting layer is connected to the previous section of the wrap film through a first adhesive layer.

2. The wrap film joint structure according to claim 1, wherein a length of the connecting layer is greater than a length of the wrap film between the first adhesive layer and a connection position of the connecting layer in the subsequent section of the wrap film.

3. The wrap film joint structure according to claim 1, wherein a bonding force between the first connecting layer and the previous section of the wrap film is greater than a bonding force between the previous section of the wrap film and the subsequent section of the wrap film;
the bonding force between the first connecting layer and the previous section of the wrap film is smaller than a bonding force between the first connecting layer and the subsequent section of the wrap film; and
a bonding force between the second connecting layer and the first connecting layer is greater than a bonding force between the second connecting layer and the first adhesive layer, and a bonding force between the first adhesive layer and the previous section of the wrap film is greater than the bonding force between the second connecting layer and the first adhesive layer.

4. The wrap film joint structure according to claim 1, wherein the first connecting layer comprises a first end portion and a second end portion; the first end portion is bonded to the subsequent section of the wrap film through a second adhesive layer; and alternatively, the first end portion is fixedly connected to the subsequent section of the wrap film; and
the second end portion is connected to the second connecting layer.

5. The wrap film joint structure according to claim 4, wherein the second connecting layer is in a flat state between the second end portion and the first adhesive layer; and alternatively, the second connecting layer is in a folded state between the second end portion and the first adhesive layer; the second end portion and the first adhesive layer are bonded to a same side of the second connecting layer; a connection area between the second connecting layer and the second end portion is greater than a connection area between the second connecting layer and the first adhesive layer; and alternatively, the second connecting layer is fixedly connected to the second end portion.

6. The wrap film joint structure according to claim 5, wherein the second connecting layer comprises a release layer; a release surface of the release layer is bonded to the first adhesive layer; and a non-release surface of the second connecting layer is connected to the second end portion.

7. The wrap film joint structure according to claim 1, wherein the first connecting layer is in a folded state, with a bending position bonded to the previous section of the wrap film.

8. The wrap film joint structure according to claim 7, wherein the first connecting layer and the wrap film are made of a same material.

9. A crop wrap film, comprising:
a wrap film, and
the wrap film joint structure according to claim 1, wherein the wrap film joint structure is located on the wrap film.

10. The crop wrap film according to claim 9, wherein the crop wrap film comprises a cotton wrap film.

11. The crop wrap film according to claim 9, wherein in the wrap film joint structure, a length of the connecting layer is greater than a length of the wrap film between the first adhesive layer and a connection position of the connecting layer in the subsequent section of the wrap film.

12. The crop wrap film according to claim 9, wherein in the wrap film joint structure, a bonding force between the first connecting layer and the previous section of the wrap film is greater than a bonding force between the previous section of the wrap film and the subsequent section of the wrap film;
the bonding force between the first connecting layer and the previous section of the wrap film is smaller than a bonding force between the first connecting layer and the subsequent section of the wrap film; and
a bonding force between the second connecting layer and the first connecting layer is greater than a bonding force between the second connecting layer and the first adhesive layer, and a bonding force between the first adhesive layer and the previous section of the wrap film is greater than the bonding force between the second connecting layer and the first adhesive layer.

13. The crop wrap film according to claim 9, wherein in the wrap film joint structure, the first connecting layer comprises a first end portion and a second end portion; the first end portion is bonded to the subsequent section of the wrap film through a second adhesive layer; and alternatively, the first end portion is fixedly connected to the subsequent section of the wrap film; and
the second end portion is connected to the second connecting layer.

14. The crop wrap film according to claim 13, wherein in the wrap film joint structure, the second connecting layer is in a flat state between the second end portion and the first adhesive layer; and alternatively, the second connecting layer is in a folded state between the second end portion and the first adhesive layer; the second end portion and the first adhesive layer are bonded to a same side of the second connecting layer; a connection area between the second connecting layer and the second end portion is greater than a connection area between the second connecting layer and the first adhesive layer; and alternatively, the second connecting layer is fixedly connected to the second end portion.

15. The crop wrap film according to claim 14, wherein in the wrap film joint structure, the second connecting layer comprises a release layer; a release surface of the release layer is bonded to the first adhesive layer; and a non-release surface of the second connecting layer is connected to the second end portion.

16. The crop wrap film according to claim 9, wherein in the wrap film joint structure, the first connecting layer is in a folded state, with a bending position bonded to the previous section of the wrap film.

17. The crop wrap film according to claim 16, wherein in the wrap film joint structure, the first connecting layer and the wrap film are made of a same material.
